(19) United States
(12) Patent Application Publication
(10) Pub. No.: US 2025/0114779 A1
(43) Pub. Date: Apr. 10, 2025

(54) A METHOD OF MAKING A CATALYTIC COMPOSITION

(71) Applicant: JOHNSON MATTHEY PUBLIC LIMITED COMPANY, London (GB)

(72) Inventors: Sanyuan YANG, Savannah, GA (US); Alessandro TURRINA, Billingham (GB); Daniel GILLELAND, Savannah, GA (US); Logan SPELL, Savannah, GA (US); Maria Pia RUGGERI, Reading Berkshire (GB)

(21) Appl. No.: 18/293,417

(22) PCT Filed: Jun. 16, 2022
(86) PCT No.: PCT/GB2022/051524

§ 371 Date: Jan. 30, 2024

Related U.S. Application Data
(60) Provisional application No. 63/203,780, filed on Jul. 30, 2021.

(51) Int. Cl. B01J 37/30; B01D 53/94; B01J 29/70; B01J 29/76; B01J 37/00; C01B 39/02; C01B 39/48

(52) U.S. Cl. CPC B01J 37/30; B01D 53/9418; B01J 29/7065; B01J 29/763; B01J 37/0018; C01B 39/026; C01B 39/48; B01D 2255/50; B01D 2257/404; B01D 2258/012; B01J 2229/18

(57) ABSTRACT

The present invention relates to a method for making a catalytic composition and, in particular, to a composition for treating a NOx-containing exhaust gas. The composition comprises a small-pore zeolite having a SAR of 9-30 and one or more rare earth metals. The method achieves the introduction of higher levels of rare earth (RE) metals into a zeolite than can be achieved with conventional wash-coating approaches.

The present invention relates to a method for making a catalytic composition and, in particular, to a composition for treating a NOx-containing exhaust gas. The method achieves the introduction of higher levels of rare earth (RE) metals into a zeolite than can be achieved with conventional wash-coating approaches.

NH₃-SCR is the most effective technique for NOx abatement in lean-burning engine exhaust after-treatment. In this regard, Cu-SSZ-13 has been commercialized as an NH₃-SCR catalyst for its significant advantages of excellent catalytic performance and hydrothermal stability. However, with more and more stringent restrictions imposed on emissions from engine exhausts, especially for vehicles under cold start conditions, further enhancing the low-temperature NH₃-SCR activity and hydrothermal stability of SCR catalysts is highly desirable.

Small pore zeolites like CHA and AEI with low silica to alumina ratio (SAR) usually have a higher fresh activity but lower durability than high SAR framework under comparable SCR working conditions. To improve the overall performance of low SAR structures, it is necessary to enhance the durability.

WO2019223761A1 discloses rare-earth-containing materials as defined by their structure type, SAR range, RE elements and their amounts either as wt % or M/Al ratio. The patent discloses RE-stabilized low SAR CHA with improved performance. The CHA was synthesis by an organic structure directing agent (OSDA)-free procedure and has an SAR of about 7.5-8.0. The uptake of Y is about 1.0-3.0 wt % based on the silica weight in the zeolite which was carried out by conventional ion exchange. In WO2019223761A1, rare earth (RE) containing low SAR CHA prepared by a conventional ion exchange method showed durability enhancement.

It is a known challenge to achieve a high uptake of trivalent metal ions (such as Fe(III), Ce(III) and La(III) etc.) in small pore zeolite (such as CHA and AEI etc.) by conventional ion exchange methods. This can be attributed to the unfavorable steric effect of the large size of hydrated cations relative to the size of zeolite pore apertures and also the disparity in charge density between the high SAR zeolite framework and trivalent cation.

WO2019223761 does not achieve a RE-CHA having a SAR substantially higher than 8 and at the same time does not achieve RE uptake substantially higher than 1 wt %. Therefore, there remains a technical need for a small pore zeolite in general and CHA in particular with both high SAR and high RE uptake. This type of material is expected to exhibit performance advantages in many applications.

U.S. Pat. No. 8,906,329 discloses the stabilization of CHA by a base metal including cerium and the performance improvement in Cu SCR application.

CN108786911A discloses a RE-containing AEI and the synthesis method. In Example 1, lanthanum nitrate and water glass were added to a concentration of 25 wt % of 1,1-dimethyl-3,5-dimethyl and, after stirring in the solution of piperidine, HY molecular sieve, NaOH and deionised water were added to form a synthesis gel that was then crystallised, filtered and calcined to obtain a La-AEI molecular sieve. The patent application did not disclose any information about SAR, RE content, XRD phase, crystal morphology, phase purity or crystallinity of the claimed RE-AEI or any XRD data or SEM about the crystal morphology of the claimed RE-AEI.

Usui et al., ACS Catal. 2018, 8, 9165-9173, titled “Improve the Hydrothermal Stability of Cu-SSZ-13 Zeolite Catalyst by Loading a Small Amount of Ce” discusses the high Cu loading capacity on ion exchange sites and how abundant acid sites are responsible for the high activity of low SAR Cu-CHA. For a given SAR, the stability of zeolite structures or retention of crystallinity under aging conditions has an optimal Cu loading which decreases with increase of hydrothermal aging temperature. This is because high Cu loading and Al-rich frameworks under aging conditions are susceptible to the formation of inactive CuOx species and framework dealumination respectively. Loading of a small amount of cerium can significantly enhance the stability of CHA with high Cu loading. The high Cu loading is essential to the high activity. For CHA with an SAR ˜13, the best results were found with 0.2-0.4 wt % of Ce loading. To explain the stabilization effects, the authors suggested that Ce ion can fill the crystal defects or neutralize the silanol groups thus enhancing the stability, and also Ce ion on the ion exchange sites can better stabilize the framework than protons. Cerium can be loaded by either conventional solution ion exchange or solid-state reaction with no difference on performance. At high uptake, not all cerium ions occupy ion exchange sites as evidenced by the presence of CeO₂ by XRD, indicating a limitation of Ce uptake to ion exchange sites.

Li et al., Ind. Eng. Chem. Res. 2020, 59, 5675-5685, titled “A Density Functional Theory Modeling on the Framework Stability of Al-Rich Cu-SSZ-13 Zeolite Modified by Metal Ions” applies a computational modelling method to rationalize the Y stabilization effect on an Al-rich CHA structure through the selective siting of Cu in the framework 6-rings promoted by the selective siting of Y in the framework 8-rings, and also the formation of multiple coordination bonds between RE and zeolite framework O.

Zhao et al., Catal. Sci. Technol., 2019, 9, 241, titled “Rare-earth ion exchanged Cu-SSZ-13 zeolite from organotemplate-free synthesis with enhanced hydrothermal stability in NH3-SCR of NOx” examines several RE elements (Ce, La, Sm, Y, Yb) and found that Yttrium gave the highest stabilization effect on Al-rich CHA synthesized by OSDA-free procedure. With increasing Y uptake, the Cu-CHA exhibited improved low temperature NO conversion activity even after hydrothermal aging. Experimental evidences were provided to show that Y species are incorporated in the ion exchange sites of the CHA structure, Y can stabilize the framework Al and also preserve the Brønsted acid sites in Al-rich CHA.

Accordingly, it is desirable to provide an improved catalytic composition for treating a NOx-containing exhaust gas and/or to tackle at least some of the problems associated with the prior art or, at least, to provide a commercially viable alternative thereto.

According to a first aspect the present invention provides a method of making a catalytic composition for treating a NOx-containing exhaust gas, wherein the composition comprises a small-pore zeolite having a silica to alumina ratio (SAR) of 9-30 and one or more rare earth metals, the method comprising:
i) providing a large-pore precursor zeolite;
ii) introducing one or more rare earth metals into the precursor zeolite by ion exchange and calcination to form a rare earth metal-substituted precursor zeolite;
iii) converting the rare earth metal-substituted precursor zeolite into a small pore zeolite in the presence of a structure directing agent.

The present invention will now be further described. In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

In contrast to the teaching of WO2019223761, in which a zeolite structure is first formed in a synthesis step and RE incorporation was carried out in a post-synthesis ion exchange step, the RE-containing zeolite by this invention is prepared by a direct synthesis method in which RE elements are incorporated into the small pore zeolite structure as it is formed. The present invention permits the introduction of higher levels of RE metals into the structure and this provides increased durability.

In contrast to the teaching of CN108786911A, in which the rare-earth source and HY molecular sieve are added separately in preparation of the synthesis gel, in the present invention the RE metal is loaded onto the large-pore molecular sieve and calcined to fix the RE metal in the cages of the zeolite before converting the zeolite to a small-pore zeolite thereby achieved good distribution of RE metals.

Preferably, in this invention RE elements are first loaded and fixed onto a large-pore precursor, such as zeolite (USY), by ion exchange and calcination respectively, next RE-USY is converted to RE-CHA under synthesis conditions. High quality RE-containing CHA with SAR 9-30, and at the same time RE in an amount of from 0.06-3.5 wt %, e.g. 0.6-3.5 wt % based on anhydrous zeolite mass, has been made according to the method of this invention.

The method of the present invention relates to the production of a catalytic composition for treating a NOx-containing exhaust gas. Such exhaust gases are produced in combustion reactions, especially in the combustion of fuels in engines, such as gasoline and diesel automobile engines. The treatment of NOₓ by SCR to produce harmless gases, such as N₂ and H₂O is well known in the art.

The composition may be provided on a substrate for inclusion in an exhaust gas treatment system. For example, the composition may be washcoated onto a honeycomb monolith body, or provided as an intrinsic component of an extruded composition used to form a honeycomb monolith body. Techniques for forming such catalyst articles comprising catalytic compositions are well known in the art.

The composition comprises a small-pore zeolite having a silica to alumina ratio (SAR) of 9-30. Zeolites are structures formed from alumina and silica and the SAR determines the reactive sites within the zeolite structure. Small-pore zeolites possess pores that are constructed of eight tetrahedral atoms (Si⁴⁺ and Al³⁺), each time linked by a shared oxygen

These eight-member ring pores provide small molecules access to the intracrystalline void space, e.g., to NOx during car exhaust cleaning (NOx removal) or to methanol en route to its conversion into light olefins, while restricting larger molecule entrance and departure that is critical to overall catalyst performance. While a small pore zeolite is a material comprising pore openings having 8 tetrahedral atoms in a ring, a medium pore zeolite is one where the smallest pores have 10 tetrahedral atoms in a ring and a large pore zeolite is one where the smallest pores have 12 tetrahedral atoms in a ring.

Preferably the small-pore zeolite has a framework structure selected from the group consisting of AEI, AFT, AFX, CHA, EMT, GME, KFI, LEV, LTN, ERI, SWY, SAV, LTA and SFW, including mixtures of two or more thereof. In some embodiments, the small pore zeolite has a framework structure selected from the group consisting of AEI, CHA, AFX, LTA, ERI, and SWY. It is particularly preferred that the zeolite has a CHA or AEI-type framework structure.

Preferably the small-pore zeolite has a silica to alumina ratio (SAR) of 10-25, more preferably 12 to 20. In some embodiments, the SAR is from 10 to 24, e.g. from 11 to 23, from 13 to 22, from 14 to 21, from 15 to 20, or from 16 to 18. These SAR values are higher than those achieved in WO2019223761. It is noted that higher SAR ratios are less acidic (fewer Al³⁺ sites) and are more stable.

Preferably the one or more rare earth metals are selected from the group consisting of Sm, Eu, Gd, Tb, Dy, Ho, Er, Tm, Yb, Lu, La, Ce, Pr, Nd, Pm, Y, and Sc and mixtures of two or more thereof. In some embodiments, the one or more rare earth metals are selected from the group consisting of La, Er, Pr, Ce and Y. Preferably the rare earth metals are selected from Y, Ce and mixtures thereof.

Preferably the small pore zeolite comprises the one or more rare earth metals in a total amount of 0.05 to 3.5 wt %, preferably 0.05 to 3.5 wt %, more preferably 0.05 to 2 wt % based on the anhydrous zeolite mass. In some embodiments, the small pore zeolite comprises the one or more rare earth metals in a total amount of from 0.1 to 3 wt %, e.g. from 0.15 to 2.8 wt %, from 0.2 to 2.5 wt %, from 0.3 to 2.2 wt %, from 0.5 to 2 wt %, from 1 to 1.8 wt %, from 1.2 to 1.5 wt % based on the anhydrous zeolite mass. This amount provides the required durability required to maintain high activity both fresh and aged.

The method comprises providing a large-pore precursor zeolite. Preferably the large-pore precursor zeolite has a USY, Beta, or ZSM-20 framework structure type, preferably the USY framework structure type.

In a first step, one or more rare earth metals are introduced into the precursor zeolite by ion exchange and calcination to form a rare earth metal-substituted precursor zeolite. Ion-exchange techniques and the required calcination are well known in the art for introducing RE metals into zeolites. For example, ion exchange and calcination can be achieved by dissolving the required rare earth metal salts (e.g. rare earth metal nitrates) into a solution. The solution can be added to a zeolite slurry (e.g. USY slurry) under stirring. The resulting mixture can then be heated (e.g. to 100° C.) for a time period (e.g. 1 hour). This can then be filtered, washed and dried to form a solid product. The resulting dry product can then be calcined (e.g. at 550° C. for 1 hour, preferably with a ramping rate 3° C./min).

In a second step the rare earth metal-substituted precursor zeolite is converted into a small pore zeolite in the presence of a structure directing agent. Examples of structure directing groups include the hydroxide or salts of: N,N,N-trimethyladamantylammonium, N,N,N-dimethylethylcyclohexylammonium, trimethyl(cyclohexylmethyl) ammonium, tetraethylammonium, N,N-Dimethyl-3,5-dimethylpiperidinium and 1,1-diethyl-2,6-dimethyl piperidinium. Preferably the structure directing agent is N,N,N-trimethyladamantylammonium hydroxide or a salt thereof. This step involves forming a synthesis gel comprising the rare earth metal-substituted precursor zeolite and the structure directing agent and then heating the gel under conditions required to form the desired end zeolite. The synthesis gel can comprise the rare earth metal-substituted precursor zeolite, a structure directing agent, water and alkali metals (e.g. Na and/or K). It is preferred that the rare earth metal-substituted precursor zeolite is used as the source material for silica and alumina. Alternative sources of Si and Al can also be used. For example, Al sources can be selected from the group comprising sodium aluminate, aluminum salts such as aluminum sulfate, aluminum nitrate, aluminum chloride, aluminum hydroxide, aluminum alkoxides, and alumina. Si sources can be selected from the group comprising sodium silicate, potassium silicate, silica gel, silica sol, fumed silica, silicon alkoxides, and precipitated silica. The synthesis gel is preferably heated at a temperature between 100 and 200° C. for between 5 hours and 10 days.

The synthesis gel can comprise the rare earth metal-substituted precursor zeolite in an amount from 1% to 30%, preferably from 2% to 15%, e.g. from 3% to 6%, from 6% to 9%, from 9% to 11% or from 11% to 15%, were the % is a wt % based on the total weight of the synthesis gel.

The synthesis gel can comprise the structure directing agent in an amount a Q/SiO₂ molar ratio from 0.01 to 0.2, preferably from 0.02 to 0.15, e.g. from 0.03 to 0.05, from 0.04 to 0.07, from 0.07 to 0.1 or from 0.1 to 0.15. Q is the structure directing agent.

The second step can involve forming a synthesis gel (e.g. a synthesis gel comprising a rare earth metal-substituted precursor zeolite and a structure directing agent), and heating the gel to a temperature and for a duration suitable for the growth of the small pore zeolite. The synthesis gel can be heated at a temperature of from 100° C. to 200° C.; more preferably from 110° C. to 190° C., 120° C. to 180° C., 120° C. to 170° C., or even 125° C. to 165° C. The duration for which the gel is heated to a suitable temperature, is preferably at least 10 hours, more preferably, 20 to 60 hours, e.g. for between 5 hours and 10 days, e.g. for between 10 hours and 8 days, between 20 hours and 7 days, between 1 and 6 days, between 2 and 5 days. It is particularly preferred that the gel is heated to these temperatures and held at these temperatures for these durations, e.g. for at least 10 hours at a temperature of from 100° C. to 200° C.

Preferably, the zeolite product resulting from heating the synthesis gel for such a temperature and duration is recovered by typical vacuum filtration. Preferably, the filtered product is washed with demineralized (also known as deionized) water is used to remove residual mother liquor. Preferably, the zeolite product is washed until the filtrate conductivity is below 0.1 mS. Preferably, the filtered and washed product is then dried at temperatures of greater than 100° C., preferably about 120° C. The dry product can then be calcined (e.g. to burn off the OSDA content). Ammonium ion exchange can then be used (e.g. to remove the alkali cations). A final calcination can then be used (e.g. to convert the product from ammonium form to activated form). These steps can be carried out by typical procedures commonly known to a skilled person in this field and are exemplified in the examples.

To prepare the synthesis gel, USY is used as the preferred source material for both silica and alumina although other source materials commonly used in zeolite synthesis could also be used. For example, Al sources can be selected from the group comprising sodium aluminate, aluminum salts such as aluminum sulfate, aluminum nitrate, aluminum chloride, aluminum hydroxide, aluminum alkoxides, and alumina. Si sources can be selected from the group comprising sodium silicate, potassium silicate, silica gel, silica sol, fumed silica, silicon alkoxides, and precipitated silica.

RE nitrate may be used as a RE metal source and other water solutions of RE salts can also be used. For example, acetate, yttrium or halogens (such as F, Cl, Br and I) can be used as RE salts.

N,N,N-trimethyladamantylammonium hydroxide solution is the preferred OSDA but other applicable OSDAs commonly known for synthesis of CHA structures can also be used. Examples of structure directing groups include the hydroxide or salts of: N,N,N-trimethyladamantylammonium, N,N,N-dimethylethylcyclohexylammonium, trimethyl(cyclohexylmethyl) ammonium, tetraethylammonium, N,N-Dimethyl-3,5-dimethylpiperidinium and 1,1-diethyl-2,6-dimethyl piperidinium.

Control of the gel composition within specific ranges are critical to form RE-containing CHA: SAR range from 10 to 100, preferably 20-50; RE/Al₂O₃ molar ratio range from 0.01 to 1.00, preferably 0.05 to 0.30; NaOH/SiO₂ molar ratio range from 0.05 to 2.00, preferably 0.15-0.95; Q/SiO₂ molar ratio range from 0.001 to 0.20, preferably 0.02-0.10; H₂O/SiO₂ molar ratio range from 5 to 100, preferably 20-50. Q is the structure directing agent.

The gel composition can have a SAR range from 10 to 100, e.g. from 20 to 90, from 30 to 80, from 40 to 70, or from 50 to 60.

The synthesis gel can have one or more, two or more, three or more or all four of the following compositional molar ratios:
RE/Al₂O₃ of 0.01 to 1.00, e.g. from 0.01 to 1, 0.05 to 0.5, 0.1 to 0.3; NaOH/SiO₂ of about 0.05 to about 2.00, e.g. from 0.05 to 2, from 0.1 to 0.95, 0.15 to 0.95, 0.2 to 0.9, 0.3 to 0.8 or 0.5 to 0.7;
Q/SiO₂ of about 0.001 to about 0.20, e.g. from 0.001 to 0.2, 0.01 to 0.15, 0.02 to 0.1, 0.05 to 0.9, 0.1 to 0.8 or 0.2 to 0.5;
H₂O/SiO₂ of about 5 to about 100, e.g. from 10 to 80, from 20 to 75, from 30 to 60 or from 40 to 50.

The crystallization temperature ranges from 100° C. to 200° C., preferably 110-180° C. Time for complete crystallization is between 5 hours to 10 days, preferably 10-60 hours. After crystallization, the as-synthesized zeolite is recovered from the synthesis mixture by a usual solid-liquid separation method and washed with demineralized water until the conductivity of the filtrate is less than 0.1 mS. The filter cake is then oven dried to reduce the surface water and obtain a dry powder product. The calcination of the dry product to burn off the OSDA content, followed ammonium ion exchange to remove the alkali cations, and a final calcination to convert the product from ammonium form to activated form are carried out by typical procedures commonly known to a skilled person in this field and are exemplified in the examples.

Powder X-ray diffraction (PXRD) is used to determine the crystallinity of the intended zeolite structure and identify the absence or presence of impurity phases. Scanning electron microscopy (SEM) is used to examine the crystal morphology of the formed zeolite product. X-ray fluorescence spectroscopy (XRF) is used to determine the elemental composition of the formed zeolite.

Preferably, the small pore zeolite has a crystallinity of greater than 90%, preferably greater than 95%, even more preferably greater than 98%.

Preferably, the small pore zeolite has a granular particle. That is, it is preferred that the zeolite has a particulate morphology whereby the zeolite crystals have a three dimensional shape in contrast to rod like particles having a substantially one dimensional shape or disk or plate like particles having a two dimensional shape. It is preferred that the zeolite has a granular particle comprising or consisting of cubic crystals. In one embodiment, the small pore zeolite has a cuboid morphology.

Preferably the small pore zeolite further comprises one or more transition metals selected from the group consisting of Cr, Mn, Fe, Co, Ce, Ni, Cu, Zn, Ga, Mo, Ru, Rh, Pd, Ag, In, Sn, Re, Ir, Pt, and mixtures thereof. These are preferably in a total amount of 0.1 to 6 wt %, preferably 2 to 5 wt %, more preferably 2 to 4 wt %. The transition metals can be in a total amount of from 0.1 to 6 wt %, e.g. from 0.5 to 5.5 wt %, from 1 to 5 wt %, from 1.5 to 4.5 wt %, from 2 to 4 wt %, or from 2.5 to 3 wt %. The transition metals can be selected from Cu, Fe, Mn, Pt, Pd and Rh. The most preferred transition metals are Cu and/or Fe.

According to a second aspect, the present invention provides a catalytic composition for treating a NOx-containing exhaust gas, the catalytic composition being obtainable according to the method of the first aspect described above, wherein the small pore zeolite of the catalytic composition has a SAR of 9-30 and one or more rare earth metals.

According to a third aspect, the present invention provides use of the catalytic composition for selective catalytic reduction of NOx in a NOx-containing exhaust gas.

The invention will now be described further in relation to the following non-limiting examples.

### EXAMPLE 1 (P04D2QA)

USY was first ion exchanged with Yttrium(III) and calcined. The resulting Y-USY, sodium hydroxide solution, 17.61 g of 25.5% N,N,N-trimethyladamantylammonium hydroxide solution and demineralized water were mixed to produce an initial synthesis gel. The resulting synthesis mixture is a uniform slurry and has a molar composition as listed in Table 1.

Next the synthesis mixture was transferred to a reactor for crystallization.

The prepared synthesis mixture was sealed in a 600 mL stainless steel agitated autoclave and heated to 130° C. for 22 hours of crystallization. The solid product was recovered by a conventional solid-liquid separation method, the obtained solid phase was washed with a sufficient amount of demineralized water and then dried in an oven at 120° C. XRD confirmed the resulting product is highly crystallized pure CHA. The as-synthesized solid product was calcined inside a muffle furnace heated to 550° C. with a ramping rate of 1° C./min and held at 550° C. for six hours.

The calcined product was cooled and then ammonium exchanged two times. Ammonium sulfate was used, and the ion exchange took place at 80° C. for two hours. The solid product was recovered by filtration and after washing the filter cake was dried at 120° C. The resulting NH₄-form dry product was calcined inside a muffle furnace heated with a ramping rate of 1° C./min and held at 550° C. for two hours. The final resulting product is an activated H-form and Y-containing zeolite product.

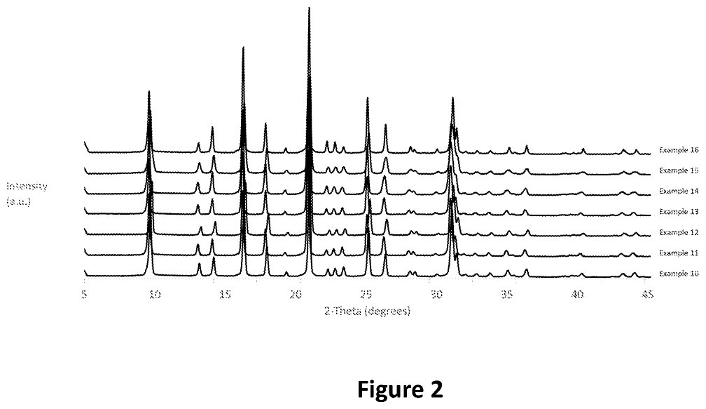

The final product exhibited the X-ray diffraction pattern of highly crystallized pure CHA structure (FIG. 2) indicating that the material remains stable after calcination to remove the organic template, ion exchange to remove alkali cation and final activation to convert from NH₄-form to H-form. The results of elemental analysis of the final activated product are listed in Table 2. The morphology of the crystal particle images was viewed by SEM.

### EXAMPLES 2-16

The procedure of Example 1 was repeated but with the amounts of starting materials being adjusted and/or cerium nitrate in place of yttrium nitrate to produce reaction mixtures having the particular mole ratios and/or incorporation of different RE elements set forth in Table 1. Crystallization and other post synthesis process steps leading to the activated form of the product were conducted in the same manner as described in Example 1 although in some cases, as shown in Table 1, the crystallization conditions (temperature and time) varied somewhat as required by the specific example for completion of crystallization. Table 2 lists the results of the product from each example.

### COMPARATIVE EXAMPLES 1-4

The synthesis of Examples 1, 8, 10 and 16 were repeated except the synthesis gels were prepared by using USY without the loading of RE by ion exchange and calcination treatment. These syntheses correspond to Comparative Examples 1, 2, 3 and 4 respectively. The resulting RE-free CHA from these Comparative Examples are used to compare the corresponding RE-containing CHA. Crystallization and other post synthesis process steps leading to the activated form of RE-free CHA were conducted in the same manner as described in the corresponding examples. Table 2 lists the results from these Comparative Examples.

TABLE 1

| | | Synthesis gel molar ratio | | | | |
|---|---|---|---|---|---|---|
| Ex. | | | | Q/SiO₂ | | Synthesis |
| No. | Si₂O/Al₂O₃ | RE/Al [1] | NaOH/SiO₂ | [2] | H₂O/SiO₂ | conditions |
| 1 | 35 | 0.0877 Y | 0.676 | 0.0294 | 29.4 | 130° C./24 h |
| 2 | 35 | 0.0621 Y | 0.676 | 0.0294 | 29.4 | 130° C./27 h |
| 3 | 35 | 0.0585 Y | 0.676 | 0.0294 | 29.4 | 130° C./24 h |
| 4 | 35 | 0.0322 Y | 0.676 | 0.0294 | 29.4 | 120° C./23 h |
| 5 | 30 | 0.0119 Y | 0.667 | 0.0333 | 33.3 | 145° C./22 h |
| 6 | 30 | 0.0054 Y | 0.667 | 0.0333 | 33.3 | 145° C./24 h |
| 7 | 30 | 0.0021 Y | 0.667 | 0.0333 | 33.3 | 145° C./31 h |
| 8 | 35 | 0.1350 Y | 0.471 | 0.0588 | 29.4 | 165° C./21 h |
| 9 | 35 | 0.1083 Y | 0.294 | 0.0882 | 29.4 | [3] |
| 10 | 35 | 0.0378 Ce | 0.686 | 0.0294 | 29.4 | 125° C./22 h |
| 11 | 35 | 0.1140 Ce | 0.686 | 0.0294 | 29.4 | 120° C./22 h |
| 12 | 35 | 0.1370 Ce | 0.686 | 0.0294 | 29.4 | 120° C./19 h |
| 13 | 35 | 0.1532 Ce | 0.686 | 0.0294 | 29.4 | 120° C./22 h |
| 14 | 30 | 0.0042 | 0.667 | 0.0333 | 33.3 | 145° C./24 h |
| 15 | 30 | 0.0209 | 0.667 | 0.0333 | 33.3 | 145° C./28 h |
| 16 | 35 | 0.1325 Ce | 0.176 | 0.0882 | 29.4 | 165° C./25 h |
| C1 | 35 | — | 0.471 | 0.0588 | 29.4 | 145° C./23 h |
| C2 | 35 | — | 0.176 | 0.0882 | 29.4 | 165° C./43 h |
| C3 | 35 | — | 0.676 | 0.0294 | 29.4 | 135° C./23 h |
| C4 | 35 | — | 0.686 | 0.0294 | 29.4 | 165° C./52 h |

[1] RE stands for rare earth metal, Yttrium and Cerium.
[2] Q stands for N,N,N-trimethyladamantylammonium hydroxide.
[3] 165° C./48 h followed by 180° C./21 h.

TABLE 2
Analysis of synthesized and processed
solid product in activated form

| Ex. No. | XRD | SAR [1] | Re wt % [1] |
|---|---|---|---|
| 1 | CHA | 14.2 | 1.56 Y |
| 2 | CHA | 13.2 | 0.93 Y |
| 3 | CHA | 13.0 | 0.76 Y |
| 4 | CHA | 12.8 | 0.63 Y |
| 5 | CHA | 13.9 | 0.24 Y |
| 6 | CHA | 13.6 | 0.11 Y |
| 7 | CHA | 13.7 | 0.06 Y |
| 8 | CHA | 20.7 | 0.71 Y |
| 9 | CHA | 26.3 | 0.63 Y |
| 10 | CHA | 11.2 | 0.75 Ce |
| 11 | CHA | 11.0 | 2.45 Ce |
| 12 | CHA | 11.4 | 3.06 Ce |
| 13 | CHA | 12.0 | 3.46 Ce |
| 14 | CHA | 13.3 | 0.13 Ce |
| 15 | CHA | 13.7 | 0.41 Ce |
| 16 | CHA | 31.2 | 1.40 Ce |
| C1 | CHA | 13.0 | — |
| C2 | CHA | 23.8 | — |
| C3 | CHA | 10.8 | — |
| C4 | CHA | 28.0 | — |

[1] Determined by X-ray fluorescence spectroscopy.

### Selective Catalytic Reduction (SCR) Performance

Activated zeolites prepared following the procedure described for Examples 5, 6 and 17 and comparative example C1 were impregnated with metal using the required amount of copper (II) acetate dissolved in de-mineralized water. The metal impregnated zeolite was dried overnight at 80° C. and then calcined in air at 550° C. for 4 hours. Copper was added to the zeolite to achieve 2.75 wt. % copper based on the total weight of the zeolite.

Each sample was pelletized and tested using a gas flow comprising 500 ppm NO, 550 ppm NH₃, 350 ppm 10% H₂O and 10% O₂. The amount of each catalyst employed in the tests was 0.3 g. The flow rate of the gas flow employed in the tests was 2.6 L/min, which equates to 520 L/hour per gram of catalyst. The sample was heated from room temperature to 150° C. under the above-mentioned gas mixture except for NH₃. At 150° C., NH₃ was added into the gas mixture and the sample was held under these conditions for 30 minutes. The temperature was then increased from 150° C. to 500° C. at a rate of 5° C./minute. The downstream gas treated by the zeolite was monitored to determine NOₓ conversion and N₂O selectivity.

A portion of the Cu impregnated samples were hydrothermally aged at 850° C. for 16 hours in air with 5% H₂O by volume. These samples were tested on the rig under conditions similar to those described in above for the fresh samples.

The invention will now be discussed further in relation to the following non-limiting figures, in which:

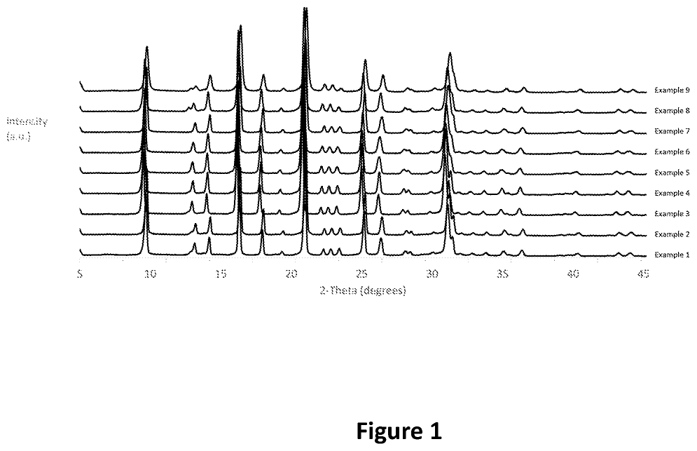

FIG. 1 shows XRD patterns of the as-synthesized Y-containing CHA structure made in Example 1, Example 2, Example 3, Example 4, Example 5, Example 6, Example 7, Example 8 and Example 9.

FIG. 2 shows XRD patterns of the as-synthesized Ce-containing CHA structure made in Example 10, Example 11, Example 12, Example 13, Example 14, Example 15, and Example 16.

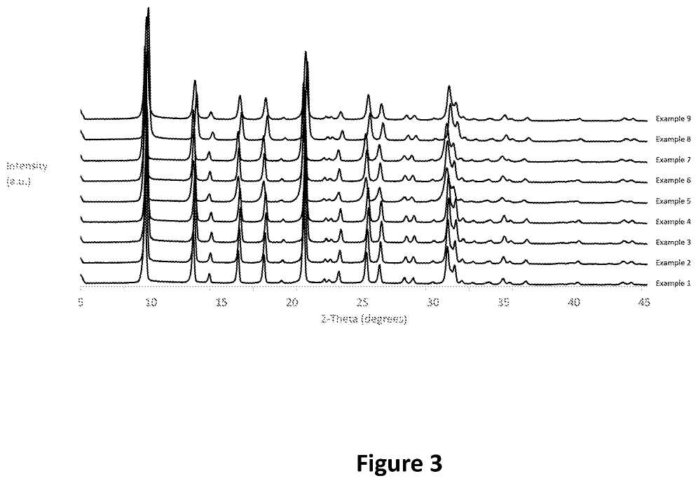

FIG. 3 shows XRD patterns of the activated Y-containing CHA structure made in Example 1, Example 2, Example 3, Example 4, Example 5, Example 6, Example 7, Example 8 and Example 9.

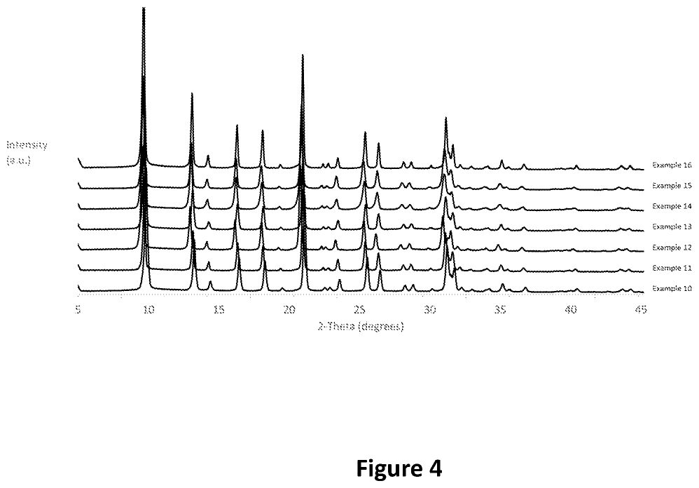

FIG. 4 shows XRD patterns of the activated Ce-containing CHA structure made in Example 10, Example 11, Example 12, Example 13, Example 14, Example 15, and Example 16.

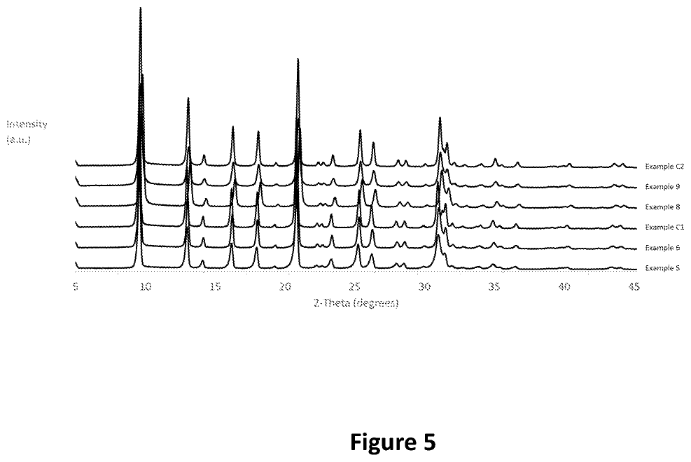

FIG. 5 shows XRD patterns of the activated Y-containing CHA structure made in Example 5, Example 6, Example 8, Example 9 and Comparative examples C1 and C2.

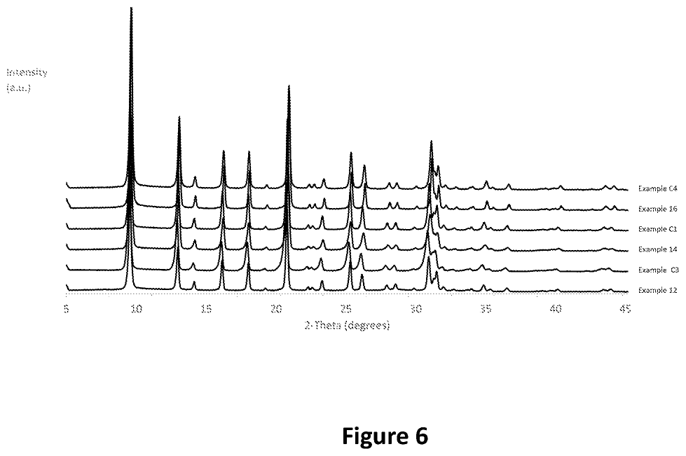

FIG. 6 shows XRD patterns of the activated Ce-containing CHA structure made in Example 12, Example 14, Example 16, and Comparative examples C1, C3 and C4.

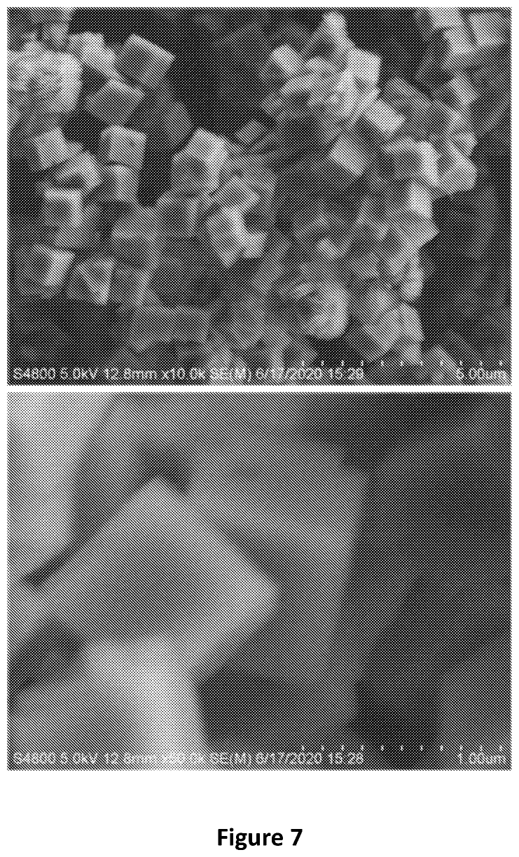

FIG. 7 shows microscopic images of the as-synthesized Y-CHA made in Example 2.

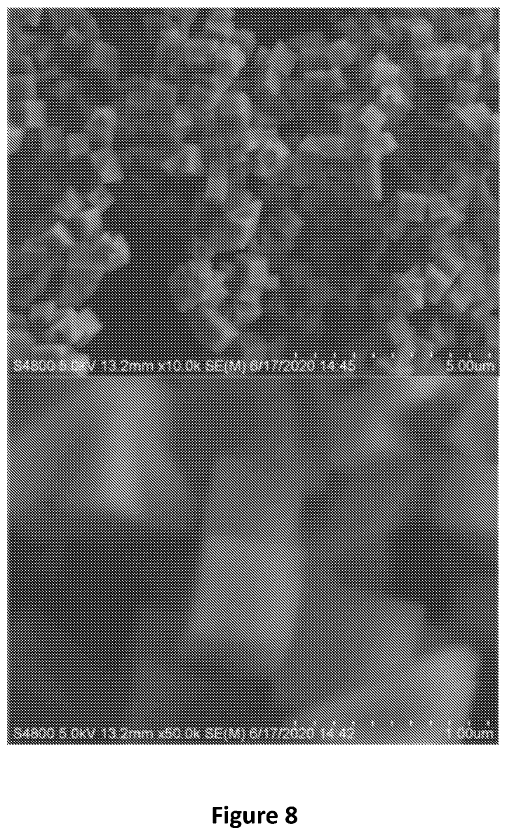

FIG. 8 shows microscopic images of the as-synthesized Ce-CHA made in Example 10.

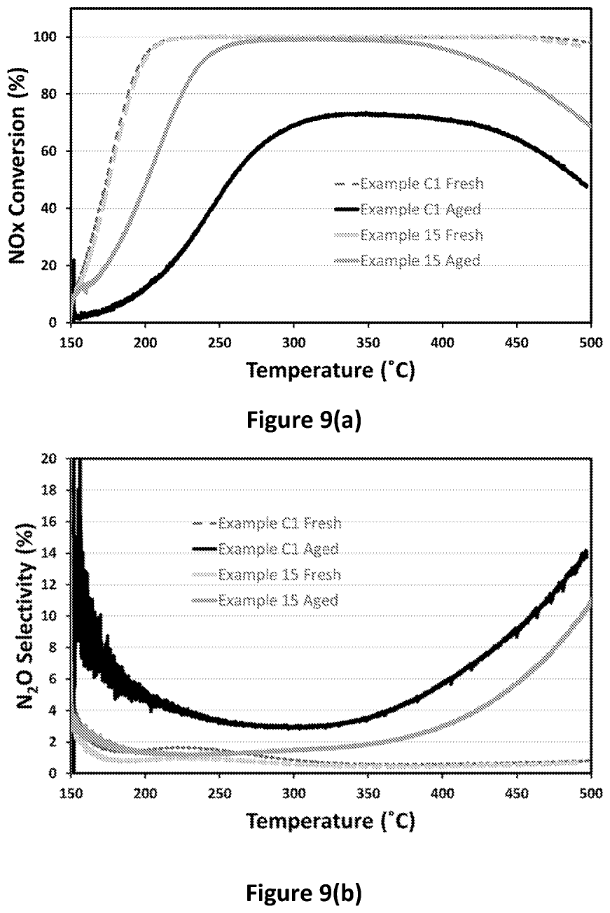

FIGS. 9(a) and(b) are graphs demonstrating the NOx conversion activity and N₂O selectivity, respectively, of the fresh and aged catalysts of example 15 and comparative example C1 tested at temperatures of 150 to 500° C. with a ramp rate of 5° C. per minute.

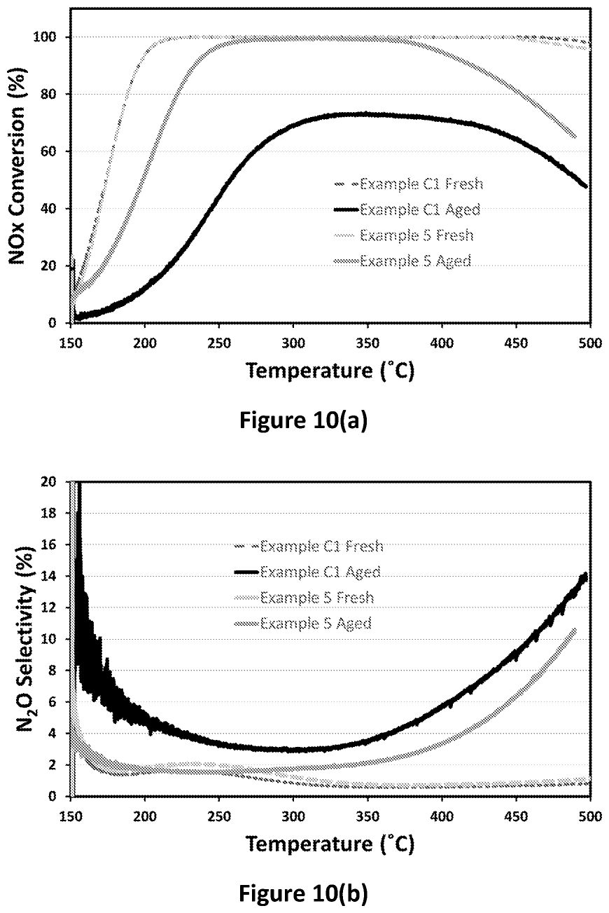

FIGS. 10(a) and(b) are graphs demonstrating the NOx conversion activity and N₂O selectivity, respectively, of the fresh and aged catalysts of example 5 and comparative example C1 tested at temperatures of 150 to 500° C. with a ramp rate of 5° C. per minute.

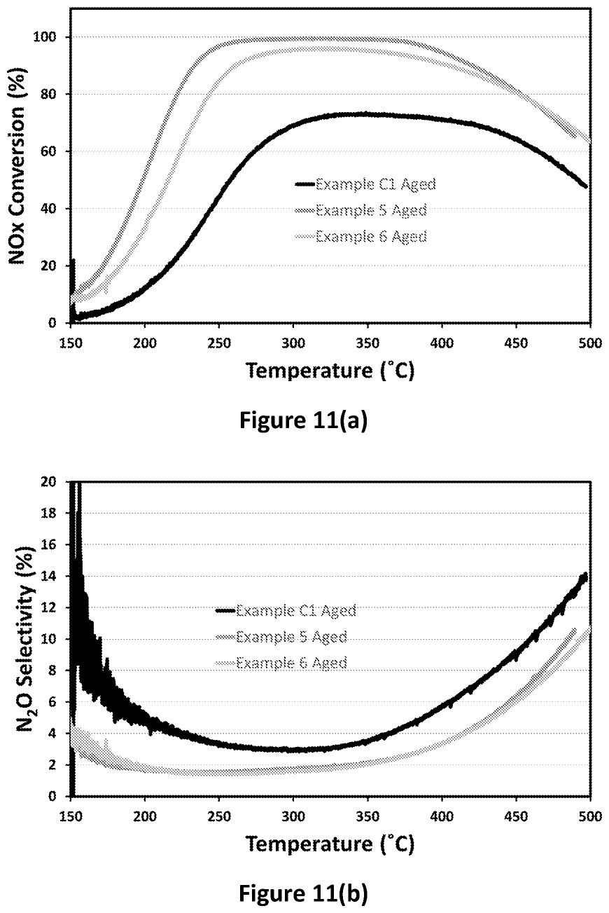

FIGS. 11(a) and(b) are graphs demonstrating the NOx conversion activity and N₂O selectivity, respectively, of the aged catalysts of examples 5, 6 and comparative example C1 tested at temperatures of 150 to 500° C. with a ramp rate of 5° C. per minute.

It was noted that some of the as-synthesized form of Y-CHA samples from Examples 1-9 have a non-CHA shoulder peak at 2-theta ˜12.65 (FIG. 1) but all of the activated forms of the same Y-CHA do not have such a shoulder peak (FIG. 3). This shoulder peak appears and grows with the increase of yttrium content in Y-CHA.

Unlike Y-CHA, as-synthesized Ce-CHA exhibits CHA-only XRD peaks (FIG. 2).

The overlaying XRD patterns of activated Y-CHA (Example 5, 6, 8, 9) and Ce-CHA (Examples 12, 14, 16) and RE-free CHA with similar SAR (Comparative Example C1, C2, C3, C4) show very well matching diffractograms in terms of peak broadening and peak positions (FIGS. 5 and 6).

The positions of RE atom in CHA structure can be either in framework as isomorphous substitution of T-atoms or off framework as extra framework species inside cages. Framework RE can also be expelled from a framework position to extra-framework position in post synthesis processing steps such as calcination treatment.

The well-shaped cube-like crystals with uniform size ˜0.5-1.0 μm of RE-CHA from Example 2 and 10 are similar to RE-free CHA made from comparable syntheses (FIGS. 7 and 8).

As shown in FIGS. 9(a) and(b), catalysts formed according to the method of the present invention and containing 0.41 wt % of ceria with a SAR of 13.7 (Example 15) demonstrated similar fresh NOx conversion and N₂O selectivity as the comparative example C1 which employ a CuCHA zeolite with approximately the same SAR of 13.

However, as shown in the same FIGS. 9(a) and(b), catalysts formed according to the method of the present invention and containing 0.41 wt % of ceria with a SAR of between 13.7 (Examples 15) demonstrate significantly improved aged NOx conversion and N₂O selectivity over temperatures of 150 to 500° C.

As shown in FIGS. 10(a) and(b), catalysts formed according to the method of the present invention and containing 0.24 wt % Y with a SAR of 13.9 (Example 5) demonstrated the same fresh activity of the comparative example C1. However, after ageing, Example 5 shows significantly improved NOx conversion and N₂O selectivity over temperatures of 150 to 500° C. compared to comparative example C1, which employs a CuCHA zeolite. It is noted that the amount of copper for both of these catalysts is the same at 2.75 wt % and so the improvement in activity is attributed to the 0.24% wt Y loading achieved by forming the zeolite according to the method of the present invention.

A similar effect is achieved where the Y loading for the catalysts is 0.11 wt %, as shown in FIGS. 11(a) and(b), which demonstrate the aged NOx conversion and N₂O selectivity of Examples 5, 6 and comparative example C1.

Therefore, FIGS. 9 to 11 demonstrate that inclusion of rare earth metals, such as ceria and yttria, in a zeolite by forming the zeolite according to the method of the present invention, achieves improved aged NOx conversion and N₂O selectivity.

Although preferred embodiments of the invention have been described herein in detail, it will be understood by those skilled in the art that variations may be made thereto without departing from the scope of the invention or of the appended claims.

1. A method of making a catalytic composition for treating a NOx-containing exhaust gas, wherein the composition comprises a small-pore zeolite having a SAR of 9-30 and one or more rare earth metals, the method comprising:
i) providing a large-pore precursor zeolite;
ii) introducing one or more rare earth metals into the precursor zeolite by ion exchange and calcination to form a rare earth metal-substituted precursor zeolite;
iii) converting the rare earth metal-substituted precursor zeolite into a small pore zeolite in the presence of a structure directing agent.

2. The method according to claim 1, wherein step (iii) comprises forming a synthesis gel comprising the rare earth metal-substituted precursor zeolite and the structure directing agent and then heating the synthesis gel to form the small-pore zeolite.

3. The method according to claim 1, wherein the small pore zeolite comprises the one or more rare earth metals in a total amount of 0.05 to 3.5 wt %, preferably 0.05 to 2 wt %.

4. The method according to claim 1, wherein the small pore zeolite further comprises Cu and/or Fe, preferably in a total amount of 0.1 to 6 wt %, more preferably in a total amount of 1 to 3 wt %.

5. The method according to claim 1, wherein the large-pore precursor zeolite has a USY framework structure type.

6. The method according to claim 1, wherein the small-pore zeolite has a CHA or AEI framework structure type.

7. The method according to claim 1, wherein the structure directing agent is N,N,N, trimethyladamantylammonium hydroxide or a salt thereof.

8. The method according to claim 1, wherein the rare earth metals are selected from Y and Ce and mixtures thereof.

9. A catalytic composition for treating a NOx-containing exhaust gas, wherein the catalytic composition is produced according to the method of claim 1, wherein the small pore zeolite of the catalytic composition has a SAR of 9-30 and one or more rare earth metals.

10. Use of the A method comprising contacting a NOx-containing exhaust gas with the catalytic composition according to claim 9.
